(19) United States
(12) Patent Application Publication
(10) Pub. No.: US 2013/0006886 A1
(43) Pub. Date: Jan. 3, 2013

(54) CRYOGENIC OPERATING SYSTEM AND METHOD

(76) Inventors: Jim ESTES, Santa Ana, CA (US); Ed Huckestein, Imperial, PA (US)

(21) Appl. No.: 13/171,251

(22) Filed: Jun. 28, 2011

(51) Int. Cl. G06Q 30/00

(52) U.S. Cl. 705/332

(57) ABSTRACT

A cryogenic data collection system includes a plurality of customer depots for the bulk storage and transfer of a cryogenic along with a signal processing module associated with each customer trailers and/or trucks and/or tractors. A plurality of customer centers for on-site storage and on-site usage of the cryogenic are provided and a signal processing module is associated with each of the customer centers. A plurality of mobile trailers provides for transfer of the cryogenic between the plurality of customer depots and the plurality of customer centers and a trailer signal processing module associated with each of the trailers, enables connection thereafter. A customer depot transfers the cryogenic to customer site locations. The trailer and/or tracks and/or tractors collects and stores data from the cryogenic operation. The data is then transferred wirelessly through a data processing signal to a website. The website can be utilized to monitor the cryogenic operation and generates automated alerts to appointed to notify of a cryogenic concern.

The present invention relates to a method and a system for monitoring and managing, particularly remotely, a cryogenics installation.

More particularly the present invention relates to wireless communication networks, specifically to network elements for implementing and monitoring as well as data collection concerning the handling and distribution of cryogenics.

Present systems do not provide complete records of the handling and storage of cryogenics and therefore there exists a need for not only monitor the cryostorage installations, but also acting immediately in response to the detection of a faulty datum or parameter, in order to permit optimal handling of the cryogenics and prevent premature failure of equipment.

### SUMMARY OF THE INVENTION

A cryogenic data collection system and method in accordance with the present invention may generally include a plurality of customer depots for the bulk storage and transfer of a cryogenic such as, for example, but not limited to air, airgas, CO₂, nitrogen, nitrous oxide, oxygen, and liquefied natural gas (LNG).

A signal processing module is provided and associated with the cryogenic data collection system, having a memory and an input and output signal receiver/transmitter for remotely receiving and transmitting system operating instructions and data relating to but not limited to time, date, volume, equipment, equipment status, and operational parameters.

A plurality of mobile trailers and/or trucks are provided for receiving and delivering cryogenic to, but not limited to, plurality of customer site locations and the plurality of customer centers. A trailer and/or truck and/or tractor signal processing module is associated with each of the trailers, each trailer and/or truck and/or tractor signal process module having a memory and input and output signal receiver/transmitter for remotely receiving and transmitting system operating instructions and data also conforming to the customer depot and customer center processing module.

More particularly, a method in accordance with the present invention enables observation and awareness of cryogenics information utilizing the system of the present invention.

Further, the method enables wirelessly communicating cryogenics information between a selected customer site location and a selected trailer and/or truck and/or tractor within communication range and wirelessly communicating additional cryogenic information between a selected customer.

Interaction of the wireless communication enables observation and awareness of the cryogenics at the customer depots, trailer, and customer centers.

Still more specifically, the method in accordance with the present invention includes wirelessly communicating cryogenic type, volume, temperature, and pressure between a selected mobile trailer and/or truck and/or tractor and a selected customer site location during transfer of a selected cryogenic between the mobile trailer and/or truck and/or tractor and the customer site location, and thereafter posting the wireless communication as a website for enabling observation and awareness of the cryogenic information.

Thus, the method according to the present invention further comprising utilizing the cryogenic information to predict premature failure of the depot, trailer, and service center.

### BRIEF DESCRIPTION OF THE DRAWINGS

The advantages and features of the present invention will be better understood by the following description when considered in conjunction with the accompanying drawings, in which:

FIG. 1 is a generalized representation of a cryogenic data collection system in accordance with the present invention generally illustrating a plurality of customer depots for the storage and transfer of a cryogenic, a plurality of customer centers for on-site storage and on-site usage of the cryogenic along with a plurality of mobile trailers for receiving and delivering the cryogenic between the plurality of customer depots and customer centers, only one of each of the elements of the present invention being represented for simplicity;

FIG. 2 is another representation of the system in accordance with the present invention and method for enabling observation and awareness of a cryogenic specifically for use with the system illustrated in FIG. 1; and

FIG. 3 is a flow chart summary of a mobile website navigation with each block representing a web page as functionally described.

### DETAILED DESCRIPTION

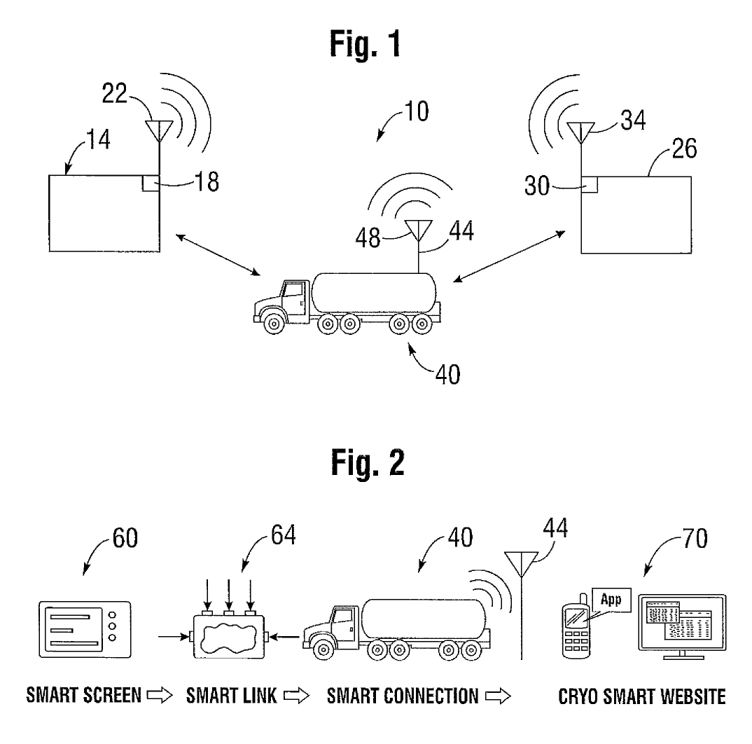

With reference to FIG. 1 there is shown a representation of a cryogenic data collection system 10 in accordance with the present invention generally includes a plurality of customer depots 14 for bulk storage and transfer of a cryogenic (not shown). A customer depot signal processing module 18 is provided and associated with the customer depot 14. Although not explicitly shown, each customer depot signal processing module 18 includes a memory along with an input and output signal receiver transmitter 22 for receiving and transmitting system operating instructions and data. Such instruction and data including but not limited to times, dates, volumes, equipment, equipment status, and operational parameters.

A plurality of customer site locations 26 are provided for on-site storage and on-site usage of the cryogenic and a service center signal processing module 30 associated with each of the customer centers 26 includes a memory input and output signal receiver transmitter 34 for remotely receiving and transmitting system operating instructions and data.

A plurality of mobile trailers and/or trucks and/or tractors, only one being shown for clarity, provide for receiving and delivering the cryogenic between the plurality of customer depots 14 and the plurality of customer site locations 26. Associated with each trailer and/or trucks and/or tractors 40, is a signal processing module 44 including a memory and input and output receiver transmitter 48 for remotely receiving and transmitting system operating instructions and data.

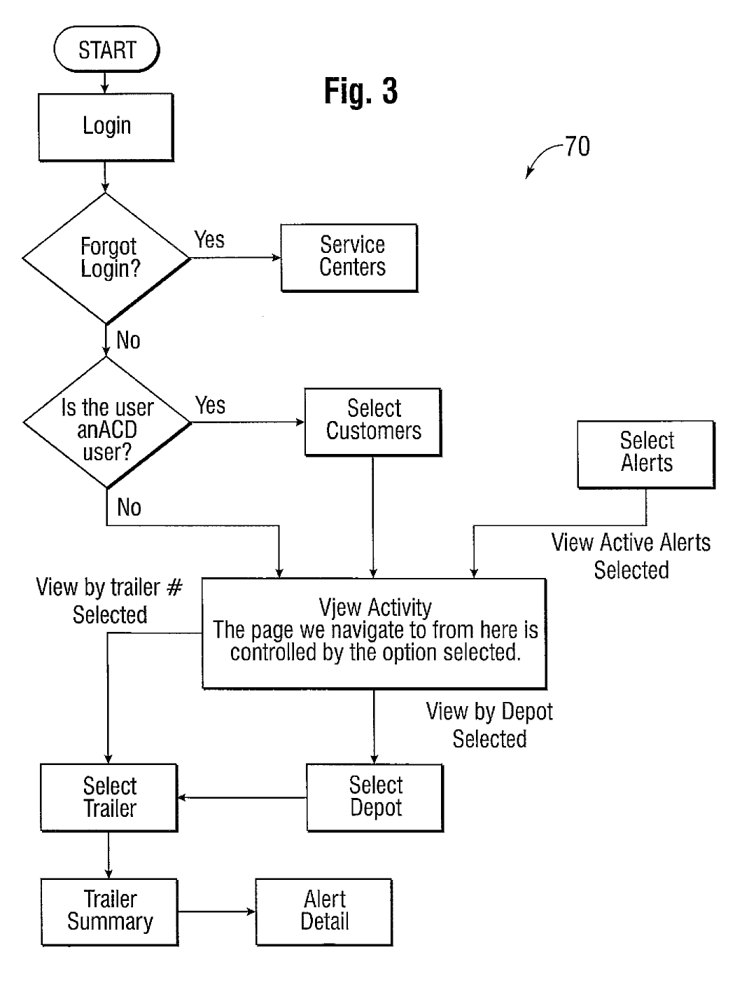

In this manner, various data on the cryogenic trailer and/or trucks and/or tractors 40 with, but not limited to, temperature and pressure sensors (not shown) during operation with the storage and data uploaded via a smart link and smart screen 60 (see FIG. 2) to the customer depot 14 and also a website illustrated in FIG. 3. This information is available for customer observation and awareness which includes, among other functions, the likelihood of liquid transfer premature failure of any of the components of the system 10.

With reference to FIG. 2, a smart screen 60 interconnected with the components of the system 10 in accordance with the present invention is utilized for programming parameters such as the trailer 40 including configuration liquid-type trailer identification and displays a real time data graphically for user.

Monitoring of a seal leak detection, discharge temperature, pair temperature, suction pressures, discharge pressure, rpm and other parameters are provided by a smart link computer 64 which is in communication, as hereinabove noted, with the customer depots 14, customer site locations 26, and trailers 44. This smart connection automatically uploads smart link by data, via the wireless transmitter receiver 44 as a truck 40 pulls within communication range of the customer depot 14 or customer site locations 26 or in close proximity of the wireless communication 44 before, during, and after transfer of a selected cryogenic. Received and transmitted data is processed by the signal processing module 44.

All the information is provided to a website as illustrated in FIG. 3 so illustrating website navigational control 70.

The website 70 can be designed in a conventional manner for a number of different users such as, regular users for receiving alerts, viewing data, and generating reports from the system.

A super user includes all of the privileges of a regular user but in addition can add or remove users within a given company or modify a system list that a regular user can use.

Further advanced users can be assigned further control over the system in a conventional manner.

Although there has been hereinabove described a specific cryogenic data collection system and method in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A cryogenic data collection system comprising:
a plurality of customer depots for the bulk storage and transfer of a cryogenic;
a customer signal processing module associated with each of the customer depots and/or job site locations, each customer module having a memory and a signal receiver/transmitter for remotely receiving and transmitting system operating instructions and data;
a plurality of customer site locations for on-site storage and on-site usage of the cryogenic;
a customer site location signal processing module associated with each of the customer centers, each customer center site location processing module having a memory and a signal receiver/transmitter for remotely receiving and transmitting system operating instructions and data;
a plurality of mobile trailers and/or trucks and/or tractors for receiving and delivering of the cryogenic between the plurality of customer depots and the plurality of customer site locations; and
a trailer and/or trucks and/or tractors signal processing module associated with each of the trailers, each trailer and/or trucks and/or tractors signal processing module having a memory and a signal receiver/transmitter for remotely receiving and transmitting system operating instructions and data.

2. A method for enabling observation and awareness of cryogenics utilizing the system of claim 1, said method comprising:
a) wirelessly communicating cryogenics information between a selected customer depot and a selected trailer and/or trucks and/or tractors within communication range;
b) wirelessly communicating additional cryogenic information between a selected customer center and the selected trailers within communication range;
c) repeating steps a) and b) in order to enable observation and awareness of the cryogenics at the depots, trailers, and service centers.

3. A method for enabling observation and awareness of cryogenics utilizing the system of claim 1, said method comprising:
wirelessly communicating cryogenic type, volume, temperature, and pressure between a selected mobile trailer and/or trucks and/or tractors and a selected customer depot during transfer of a selected cryogenic between the selected site location and the selected trailer;
wirelessly communicating cryogenic type, volume, temperature, and pressure between the selected mobile trailer and/or trucks and/or tractors and a selected service center during transfer of the selected cryogenic between the selected site location and the selected trailer; and
posting the wireless communication on a website for enabling observation and awareness and automated alerts of the cryogenics.

4. The method according to claim 2 further comprising utilizing the cryogenic information to predict premature liquid transfer failure of the customer depots, trailers, and customer centers
